(19) United States
(12) Patent Application Publication
(10) Pub. No.: US 2007/0220203 A1
(43) Pub. Date: Sep. 20, 2007

(54) Management method for virtualized storage view

(75) Inventor: Atsushi Murase, Sunnyvale, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 11/377,075

(22) Filed: Mar. 15, 2006

(51) Int. Cl. G06F 12/16

(52) U.S. Cl. 711/114

(57) ABSTRACT

The Storage Management System includes a client host, storage device, and storage management server configured to provide virtualized storage topology. The storage management server holds information on both the physical topology of the devices and the virtualized system configuration. In addition, the storage management server holds status information indicating whether each element is shown virtually or physically. The server creates latest topology data to be drawn from its physical topology and virtualized configuration according to the status above that indicates which topology must be shown in each portion of the system. Thereafter, the server draws created topology on the screen. The user is enabled to switch between the physical and virtual representations, which prompts the server to redraw Status of each portion are able to switch to the other by user so that after redraw process has done the specified potion will be shown in other perspective. Properties of both virtual and physical perspective are shown in according to the user's request of each point in time. By having both physical and virtual configuration and also displaying status of each portion this invention provides mixed topology to the administrator in the understanding way of them to recognize and operate their environment.

### DESCRIPTION OF THE INVENTION

1. Field of the Invention

The present invention generally relates to storage systems and more particularly to systems using storage virtualization technology.

2. Description of the Related Art

A variety of storage virtualization technologies allow user to create and use virtual storage devices. A virtual storage device appears to the user just like a physical storage unit. One of the advantages of the virtualization is the ability to create storage devices of any desired size or having a desired partitioning structure. For instance, multiple storage consolidation technology, well known to persons of skill in the art, enables one to create a single storage pool of a very large size. On the other hand, the logical partitioning technology enables users to have multiple small virtual storage devices allocated within a single physical device.

However, because of the complexity involved in the management of the storage area network (SAN), storage administrators usually require some topology managing tool to visualize the complex hierarchy of various devices within the storage system. Such devices may include, without limitation, storage arrays, SAN switches, and various host systems. However, the currently available tools are only able to show the physical connectivity of the devices. Therefore, the currently available tools are not able to handle the complexity associated with the virtualization storage environment.

It should be noted that storage system administrators desire to view or operate virtual storage devices virtually in a specific perspective, in other words, the consolidated storage should be shown as single element instead of multiple elements, while the partitioned storage should be shown as individual elements instead of a single element. Moreover, the properties of each element of the storage system topology must also be shown individually. On the other hand, it is also desirable to enable the storage system administrators to view the actual physical elements which correspond to the virtual element in the other specific perspective. Further, it may be desirable to additionally display physical conditions such as performance of individual storage disks. Furthermore, the various views of the storage system topology should be easily switchable between one another at any portion of the storage environment that the user may focus on.

Therefore, it would be desirable to provide a solution enabling the storage administrators to recognize and manage both virtual and physical aspects of the storage system hierarchy by incorporating the necessary functionality into the appropriate virtual topology management tools.

### SUMMARY OF THE INVENTION

The inventive methodology is directed to methods and systems that substantially obviate one or more of the above and other problems associated with conventional techniques for data replication.

In accordance with one aspect of the invention, there is provided a computerized data storage system and an associated method and computer programming product. The inventive system includes at least one physical storage device with a storage controller and least one storage disk. The physical storage device(s) is apportioned into at least one logical partition. The inventive system additionally includes a client host executing client software; and a storage management server executing a virtual storage manager. The storage management server includes a central processing unit, a memory and a network interface connecting the storage management server to the storage device and the client host via a network. The virtual storage topology module obtains information about the physical topology associated with the storage system. The aforesaid physical topology includes information on the physical storage device(s). The virtual storage topology module also obtains information on the virtual topology associated with the storage system. The virtual topology includes information on the logical partition(s) within the storage system. The virtual storage topology module further causes a first portion of the physical topology information and a second portion of the virtual topology information top be displayed within the same topology view.

In accordance with another aspect of the invention, there is provided a method and a computer programming product for visualizing a topology associated with a computerized data storage system. The storage system includes at least one physical storage device. In accordance with the inventive method, information about the physical topology associated with the storage system is obtained. The physical topology includes information on the physical storage device(s). The inventive method further includes obtaining information on the virtual topology associated with the storage system. The aforesaid virtual topology includes information on logical partitions within the storage system. The inventive method further involves displaying a first portion of the physical topology information and a second portion of the virtual topology information to a user within the same topology view.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows an exemplary embodiment of the hardware architecture.

FIG. 2 shows an exemplary embodiment of the logical element structure.

FIG. 3 shows an exemplary embodiment of the data structure of physical topology table.

FIG. 4 shows an exemplary embodiment of the data structure of a logical partition table.

FIG. 5 shows an exemplary embodiment of the data structure of a drawing topology table.

FIG. 6 shows an exemplary embodiment of the user interface for physical storage view.

FIG. 7 shows an exemplary embodiment of the user interface for a virtualized storage view.

FIG. 8 shows the first part of an exemplary embodiment of a process for creating a drawing topology table.

FIG. 9 shows the second part of an exemplary embodiment of a process for creating a drawing topology table.

FIG. 10 shows an exemplary embodiment of a process for drawing a topology.

FIG. 11 shows an exemplary embodiment of a process for switching display of a storage device portion within the topology.

FIGS. 12 and 13 illustrate an exemplary embodiment of the user interface of the inventive Virtualized Storage Manager operating in connection with an alternative implementation of the storage virtualization system.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

### First Embodiment

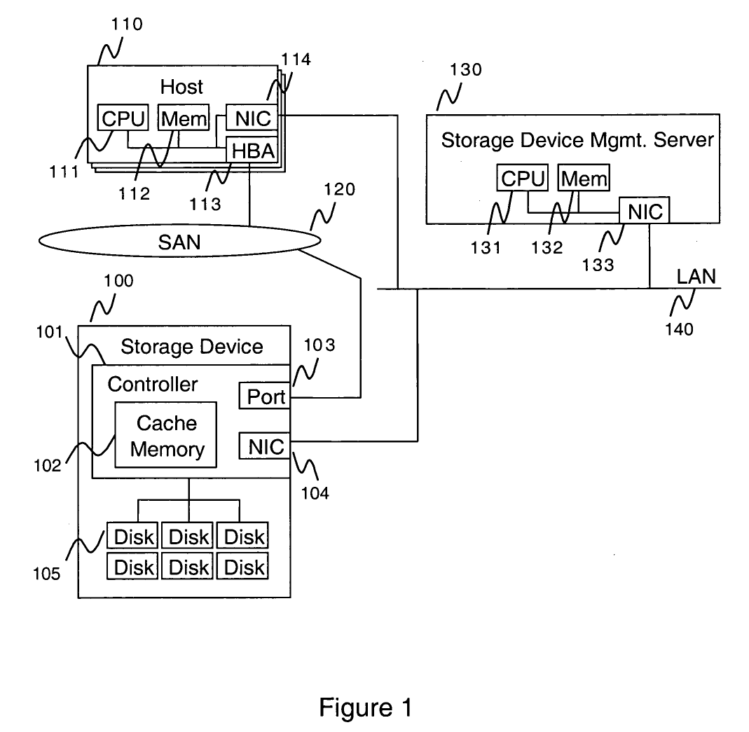

1. Hardware Architecture (FIG. 1)

FIG. 1 illustrates an exemplary implementation of physical hardware architecture in accordance with the first embodiment of the inventive concept.

1) Overall System

The overall system configuration of the first embodiment of the inventive system shown in FIG. 1 includes a Storage Device 100, Host 110, and Storage Device Management Server 130. These devices are interconnected through a storage area network (SAN) 120 and/or local area network (LAN) 140, which may be an IP-based network. The SAN may be implemented using the Fibre Channel network architecture, which is well known to persons of skill in the art. It should be noted that the system architecture may include multiple Hosts 110, which may be used by multiple users in a concurrent manner or otherwise.

2) Storage Device (100)

The storage device 100 includes a Controller 101, which is operatively coupled to a set of storage Disks 105. Additionally, a Cache Memory 102, Port 103, and Network Interface Card (NIC) 104 may be incorporated within the Controller 101. The Disks 105 may be connected to the Controller 101 by means of a storage system interconnect. The storage device 100 provides storage capacity for storing data and, in addition, may be configured to enable virtual partitioning of the storage Disks 105 into a small set of virtual devices available to the users and having a suitable degree of granularity.

3) Host (110)

The host 110 may be implemented based on a generic computer platform, which may include a CPU 111, Memory 112 as well as a Host Bus Adapter (HBA) arranged to connect the host 110 to the SAN 120. Additionally, the Host 110 may include a network interface card (NIC) 114, configured to enable the connection of the host 110 to the local area network (LAN) 140. The Host 110 is configured to enable the users of the inventive system to visualize and manage the topology of storage environment including virtualized storage devices.

4) Storage Device Management Server (130)

The storage management server 130 may be implemented using a generic computer or server platform, which may include a CPU 131, Memory 132, and NIC 133. The server 130 may incorporate a functionality enabling a user to manage the storage environment using the inventive virtualization feature.

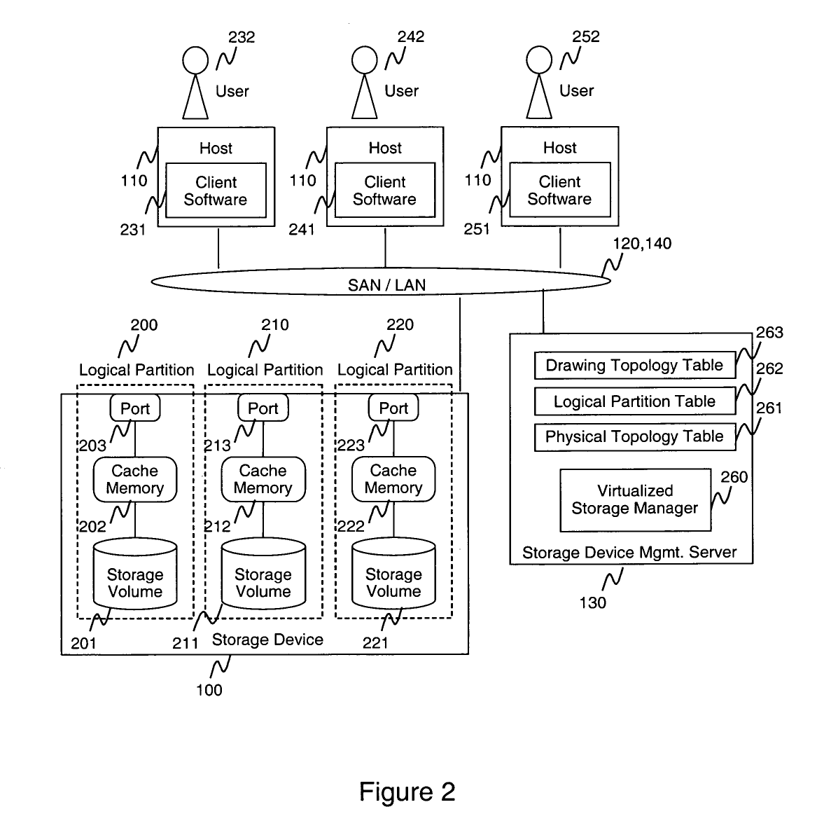

2. Logical Element Structure (FIG. 2)

FIG. 2 provides a schematic diagram illustrating exemplary software as well as a logical object structure of the first embodiment of the inventive concept.

1) Elements on the Storage Device (100)

Logical Partitions 200, 210 and 220 are created by virtually partitioning the storage device 100. These partitions may be created to have any appropriate size, as requested by the users. In one embodiment of the invention, the size of the logical partitions 200, 210 and 220 is substantially small. Each of the logical partitions 200, 210 and 220 incorporates one of the Storage Volumes 201, 211 and 221, respectively, which provides data storage capability for the respective partition. Additionally, each Logical Partition 200, 210 and 220 is assigned one of Cache Memory units 202, 212 and 222 and one of Ports 203, 213 and 223. The Storage Volumes 201, 211 and 221 and Cache Memory units 202, 212 and 222 are allocated from the storage Disk 105 as well as Cache Memory 102 of the Storage Device 100. In one implementation of the inventive system, each of the Logical Partitions 200, 210 and 220 is allocated for a particular user. For security, the user's Logical Partition is not accessible to all other users. However, the system storage administrator has privileges to access and manage the partitioning of the storage resources of the inventive system.

The aforesaid Storage Volumes 201, 211 and 221 are allocated from the combined storage resources of physical Disks 105 and are accessible to a particular Host 110, associated with the respective volume, and the corresponding User through the SAN 120. This enables the Host 110 to use the Storage Volumes 201, 211 and 221 to perform various data storage and retrieval operations.

The Cache Memory units 202, 212 and 222 are memory devices used by the inventive storage system to perform caching operation of the data which is being written or read from (to) the respective Storage Volume(s) during the storage access operation. Each of the Cache Memory units 202, 212 and 222 is allocated for each Logical Partition 200, 210 and 220 from the physical Cache Memory 102. The Cache Memory units 202, 212 and 222 may be made of any desired size.

The Ports 203, 213 and 223 are the access points of each Logical Partition. Each of the aforesaid Ports 203, 213 and 223 is connected to the particular Host 110 through the SAN 120.

2) Logical Elements of the Host (110)

The Host 110 executes client software applications 231, 241 and 251. The Client applications 231, 241 and 251 are configured to request a topology view of the storage system from the Virtualized Storage Manager. Users 232, 242 and 252 use the respective Hosts 110 to monitor and manage the operation of the Client Software 231, 241 and 251. Specifically, the software may be monitored and managed using one of Web browsers, well known to persons of skill in the art, which may execute on the Hosts 110.

3) Elements on the Storage Device Management Server (130)

The Storage Device Management Server 130 incorporates Virtualized Storage Manager 260, Physical Topology Table 261, Logical Partition Table 262 and Drawing Topology Table 263. The Virtualized Storage Manager 260 is an application operable to create a storage topology view of the target storage system. Specifically, the Virtualized Storage Manager 260 may generate graphical storage system topology representations, which may include elements of both virtual and physical topology structures.

The Physical Topology Table 261 stores information about the physical connectivity of the actual physical devices within the storage system, such as the storage Disks 105. On the other hand, the Logical Partition Table 262 holds information about the Logical Partition configuration within the Storage Device. The Drawing Topology Table 263 contains information on the storage topology to be drawn on the user's screen, which includes both virtual portions and physical portions. The virtual and physical portions are combined within the same graphical representation of the storage system topology view. The Drawing Topology Table is dynamically created by the Virtualized Storage Manager 260 in response to a request for topology information received from the Client Software.

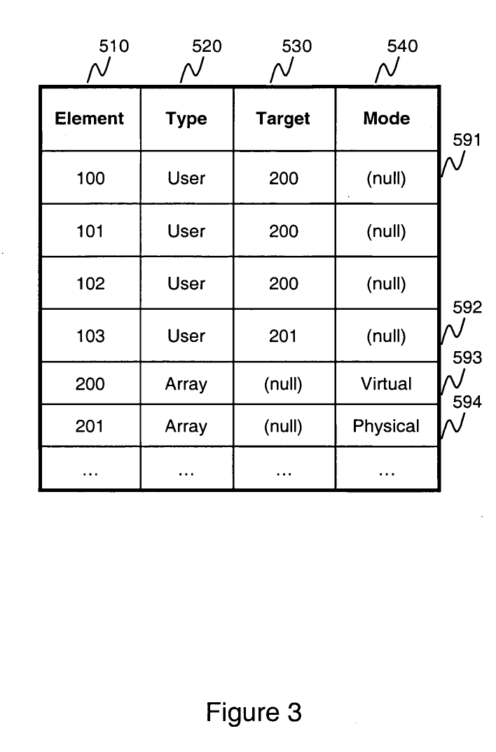

3. Data Structure (FIGS. 3, 4, 5)

1) Physical Topology Table (FIG. 3)

FIG. 3 shows an exemplary embodiment of a data structure of the Physical Topology Table. Each of the rows in the Physical Topology Table shown in FIG. 3 corresponds to an element of the physical storage system architecture. The Element column 510 of the aforesaid exemplary table contains identification of the elements on the topology, such as Arrays, Users and the like. The Type column 520 contains information indicating the type of the respective element. The Target column 530 stores information identifying another, target element of the physical topology, which is connected to the element represented by the specific row of the table. This target element is represented by another record in the Physical Topology Table and identified in the aforesaid Target field by the respective Element value.

Finally, the Mode column 540 indicates whether any specific Array element is presently shown in a virtual representation or a physical representation. For instance, row 591 represents a record of a storage topology element corresponding to a User and having an Element identification value of ‘100’. The type of the element (‘User’) is indicated in the column 520 of the table. The topology element represented by the row 591 is connected to an element with the Element identification value of ‘200’. The latter element ‘200’ is represented in the table by row 593. The type the element ‘200’ is Array, as indicated by the value in the Type column 520. It should be noted that the element ‘200’ is not connected to any specific device. However, other elements of the topology are connected to it, as indicated in the table. Finally, it should be noted that the value of ‘Virtual’ in the Mode column 540 of the element ‘200’ indicates that the element is presently being displayed to the user of the inventive system in the virtual representation mode. The Physical Topology Table is managed by the Virtualized Storage Manager to store information on the physical topology configuration of various devices of the inventive storage system as well as the manner in which storage arrays are represented in a storage system topology view at any give time.

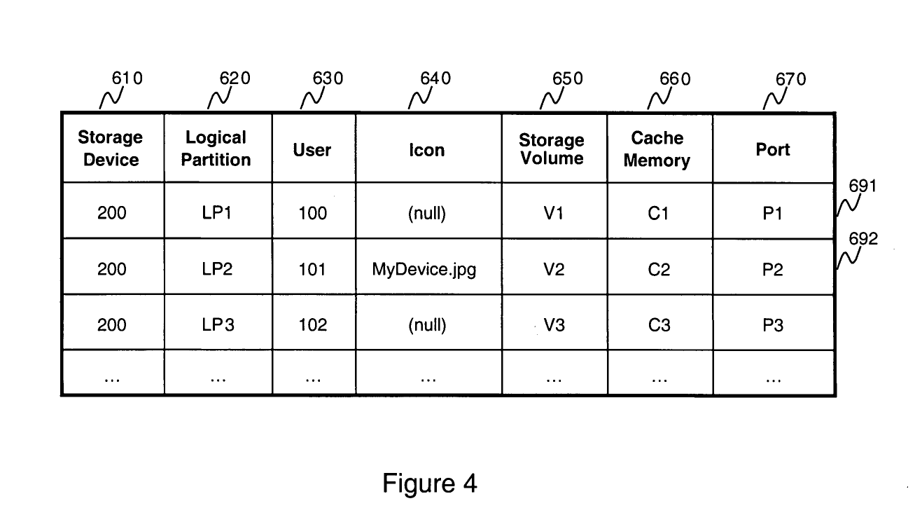

2) Logical Partition Table (FIG. 4)

FIG. 4 shows an exemplary embodiment of the data structure of the Logical Partition Table. Each row in this table represents a separate logical partition. The value in the Storage Device column 610 identifies the storage Array, which hosts the logical partition represented by the corresponding table row. The Logical Partition column 620 contains Logical Partition Identification information. The User column 630 provides information identifying the User who is allowed to use this Logical Partition.

The Icon column 640 identifies a Bitmap, which is utilized to represent the logical partition in the storage system topology view. The aforesaid bitmap may be specially drawn to represent the specific Logical Partition. The value in the Storage Volume column 650 contains Storage Volume identification information, specifying a Storage Volume, which is associated with the specific Logical Partition. The value in the Cache Memory 660 column identifies Cache Memory resource, which is allocated to the specific Logical Partition. Finally, the value in the Port column 670 identifies a Port which has been allocated to the Partition.

For instance, row 691 of the table shown in FIG. 4 represents a record corresponding to a Logical Partition, which is allocated within the Storage Device (array) 200. The Logical Partition identification value of this partition, stored in column 620 is ‘LP1’. The value in the column 630 indicates that this partition is allocated to a User ‘100’. The lack of icon information in the Icon column 640 indicates that the partition does not have any specific associated icon image. Therefore, a default array icon would be used to represent the partition in the storage system topology view. Finally, the partition is associated with the Storage Volume ‘V1’, Cache Memory ‘C1’ and Port ‘P1’.

On the other hand, a partition represented by row 692 of the aforesaid table is provided with a specific Icon image ‘MyDevice.jpg’, as evidenced by the value in the column 640. Therefore, that bitmap would be used when drawing this Logical Partition on the storage system topology view. The Logical Partition Table shown in FIG. 4 is managed by the Virtualized Storage Manager to store the Logical Partitioning configuration of the Storage Device 100 and to hold information on specific graphical primitives (icons), which, if specified, may be used to represent the logical partitions on the storage system topology view.

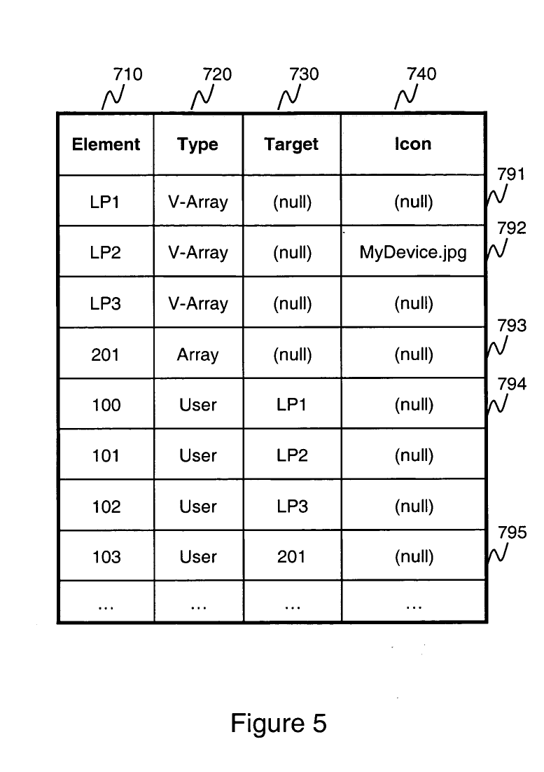

3) Drawing Topology Table (FIG. 5)

FIG. 5 shows an exemplary embodiment of the data structure of the Drawing Topology Table. Each of the columns of the aforesaid table will be described herein in detail. Specifically, the value in the Element column 710 provides identification of the element on the topology represented by the given row. The value in the Type column 720 indicates the type of the topology element. Specifically, the ‘V-Array’ value in the Type column 720 corresponds to a Logical Partition element. The value in the Target column 730 identifies another topology element to which the element represented by a specific row of the table is connected. It should be noted that the target element may be either a physical topology element or a Logical Partition. The value in the Icon column 740 identifies a Bitmap image, which is used in drawing the Logical Partition on the corresponding topology view.

For instance, row 791 of the table shown in FIG. 5 represents a record corresponding to a Logical Partition element, having the Element identification value of ‘LP1’. The values in the remaining columns of the corresponding element record indicate that the type of the aforesaid element is ‘V-Array’, and that it is not associated with any specific Icon bitmap so that the default bitmap image would be used in drawing the element on the topology view. The element represented by row 792, on the other hand, has a particular Icon image associated with it, so that the element would be drawn using the specified bitmap. The element corresponding to the row 793 of the table is represented by a physical device. Finally, row 794 indicates that the User ‘100’ is connected to the Logical Partition ‘LP1’ in the topology view. The Drawing Topology Table is created and managed by the Virtualized Storage Manager to store the topology containing both physical and virtual portions, which is to be drawn to the user of the inventive storage system.

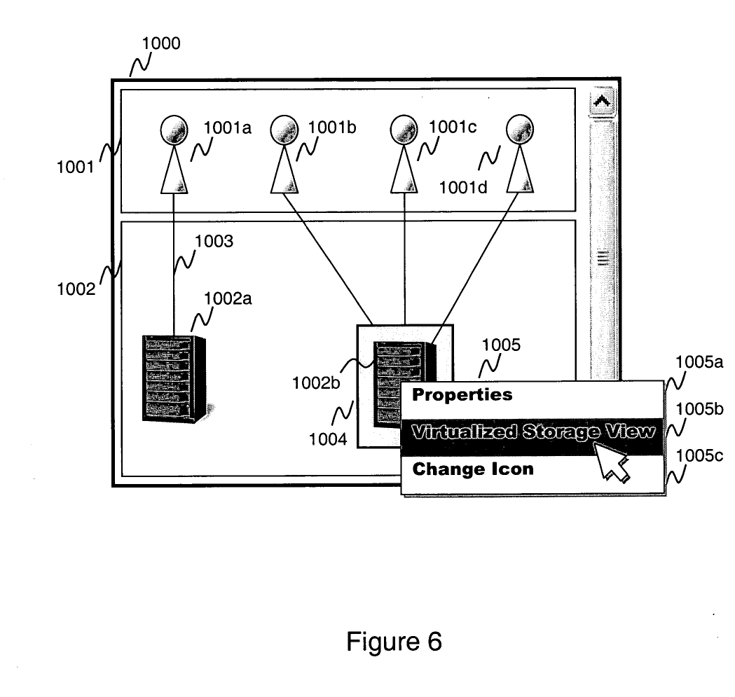

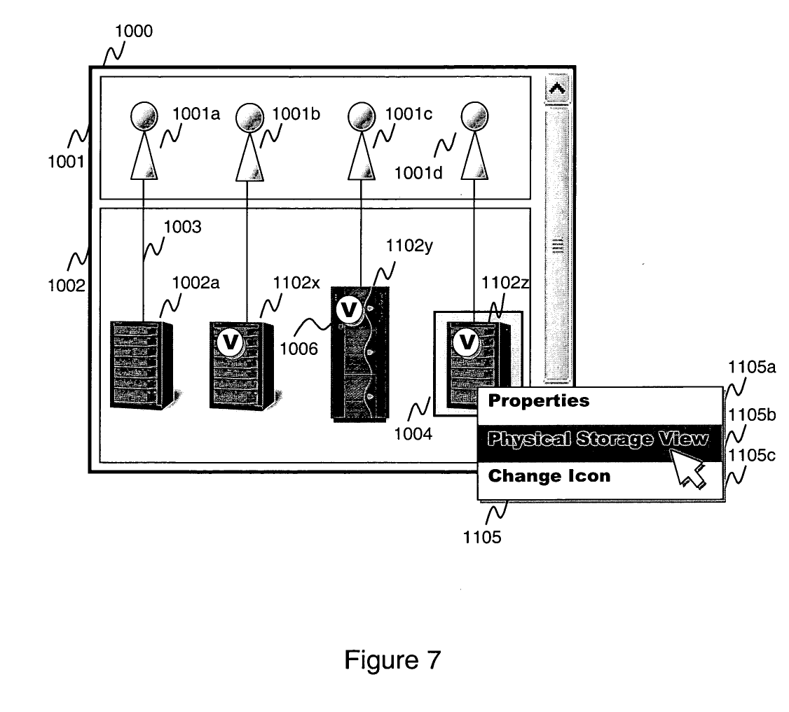

4. User Interface (FIGS. 6 and 7)

1) Physical Storage View (FIG. 6)

FIG. 6 shows an exemplary embodiment of the user interface of the Virtualized Storage Manager operating in the Physical Storage View mode. It should be noted that while the elements of the storage system topology shown in FIG. 6 are presented in a Physical Storage View representation, not all the elements of the topology need to be shown in the same representation mode. Different portions of the same topology view and/or different elements thereof may be shown in both the Physical Storage View mode and Virtualized Storage View mode.

A Screen 1000 shown in FIG. 6, depicting the topology view of the storage system in accordance with an embodiment of the inventive concept, includes a User Layer Area 1001 and Array Layer Area 1002. Icons 1001a, 1001b, 1001c and 1001d, representing the Users of the inventive system, are displayed within the aforesaid User Layer Area 1001. On the other hand, the Array Layer Area 1002 contains the Icons representing the storage Arrays. For example, in the FIG. 6, the storage device 1002b is shown using an appropriate icon image as a physical storage device, which is used by the Users 1001b, 1001c, and 1001d. The connectivity between specific Users and Arrays is indicated by means of the lines connecting the respective icons. Specifically, line 1003, connecting icon 1001a, which corresponds to a User, and icon 1002a, corresponding to a storage device, indicates that physical storage device 1002a is used exclusively by the User 1001a.

On the other hand, lines drawn between the User icons 1001b, 1001c and 1001d and the physical device 1002a show that the device 1002b is shared by the aforesaid Users 1001b, 1001c and 1001d. A user may focus on a specific Array or other topology element by clicking on the corresponding icon with a mouse button. When the element of the topology is focused on, the corresponding icon is displayed using different color palette, as shown by numeral 1004 in FIG. 6. Additionally, upon focusing on a topology element, a pop-up menu 1005 appears. This menu may include selections for various operations involving the affected storage Array. For example, exemplary selection 1005a may offer the user to display the properties of the physical array. Exemplary selection 1005b may be used by the user to switch the view mode for the Array from Physical Storage View mode to Virtualized Storage View mode. Finally, selection 1005c may be used by the user to change the icon representing the respective storage Array on the topology view to a different bitmap image.

2) Virtualized Storage View (FIG. 7)

FIG. 7 shows an exemplary embodiment of a user interface of the Virtualized Storage Manager operating in the Virtualized Storage View mode. Most of the storage topology elements shown by the user interface of FIG. 7 are the same as the corresponding elements, which were described above with reference to FIG. 6. It should be noted, however, that in FIG. 7, each Logical Partition is displayed individually within the Array Layer Area 1002 of the user interface.

Each logical partition shown in FIG. 7 is marked with a special icon designated with a numeral 1006, which indicates that the corresponding storage topology element exists virtually. The graphical representation of the connectivity of various storage elements is also different. Specifically, Users 1001a, 1001b, 1001c and 1001d are connected to the individual Logical Partitions, which are exclusively allocated to the respective users. As described above with reference to FIG. 6, upon activation of the virtual storage element by a user, a pop-up menu would also appear. However, in the Virtualized Storage View mode, the menu would include a selection for switching the device view into the Physical Storage View mode for the specific device.

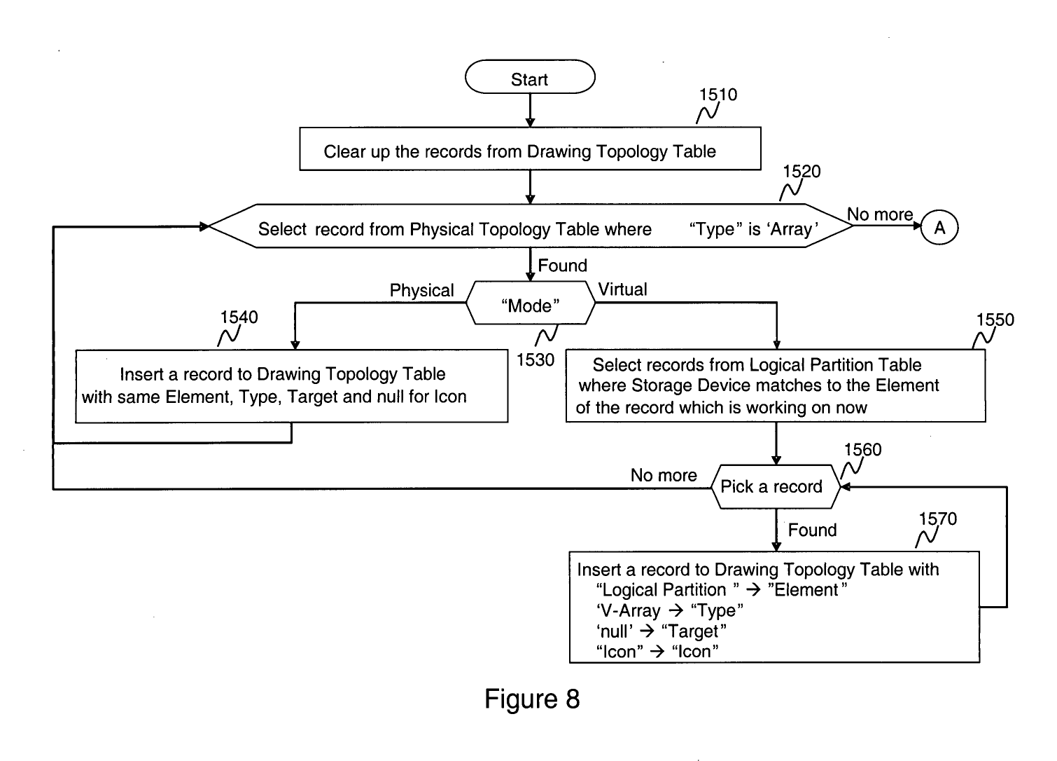

5. Process Flow (FIGS. 8, 9, 10 and 11)

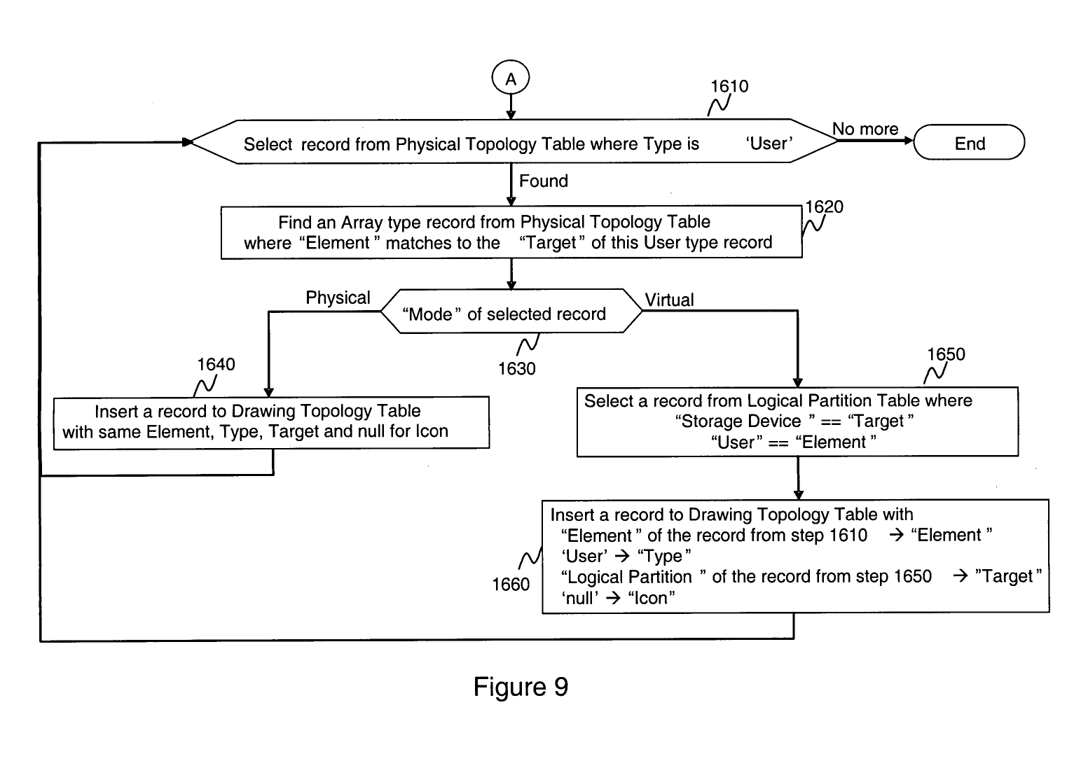

1) Creating Drawing Topology Table (FIGS. 8 and 9)

FIGS. 8 and 9 illustrate an exemplary embodiment of an operating sequence for creating a new Drawing Topology Table, which is used to redraw the storage system topology having physical and virtual portions thereof combined within a single hierarchy. Specifically, FIG. 8 shows the process flow for creating records corresponding to the ‘Array’ topology elements, while FIG. 9 shows the corresponding flow for the ‘User’ elements. The illustrated process is executed by the Virtualized Storage Manager 260.

Now, specific steps of the aforesaid operating sequences will be described in detail. First, at step 1510, all old records are cleared from the Drawing Topology Table. At step 1520, the inventive system selects all records from the Physical Topology Table shown in FIG. 3, which have type “Array” as the value of the “Type” variable 520. If there are no more such records found, the inventive process proceeds to the step 1610.

At Step 1530, the inventive system determines whether the value of the “Mode” variable 540 of the selected record is “Physical.” If so, the inventive process proceeds to step 1540. Otherwise, if the value of the aforesaid variable is “Virtual”, the process continues with the step 1550.

At step 1540, the inventive system inserts a new record representing a physical array into the Drawing Topology Table. The inserted record has the same values of the “Element”, “Type” and “Target” variables as the corresponding record which was obtained at step 1520. The “Icon” variable value of the inserted record will be set to “null”.

At step 1550, the inventive system selects all records from the Logical Partition Table shown in FIG. 4, which have the value of the Storage Device variable 610 equal to the value of the “Element” variable 510 of the record which was obtained at step 1520. The selected records represent the Logical Partitions corresponding to the physical array elements of the storage topology.

At step 1560, the inventive system picks the next record from the set of records generated as the result of the step 1550. The aforesaid step 1560, together with the step 1570, which processes the selected record, are repeated in a loop, until all such records are processed. When no more unprocessed records for the Logical Partition remain, the inventive process proceeds back to the step 1520.

At the processing step 1570, a new record representing the Logical Partition (the same as Virtual Storage) is inserted into the Drawing Topology Table.

The “Element” variable of the newly inserted record is set to the value of the “Logical Partition” variable of the record obtained at step 1560. Further, the value of the “Type” variable of the inserted record is set to “V-Array”, the value of the “Target” variable is set to “null” and the “Icon” variable is set to have the value of the “Icon” variable of the record obtained at step 1560.

At step 1610 of the process flow shown in FIG. 9, the system selects a record from the Physical Topology Table shown in FIG. 3, which has the value of its “Type” variable equal to “User”. If no more such records can be found, the process terminates.

At step 1620, the inventive system obtains the value of the “Target” variable of the “User”-type record selected at step 1610 and finds an “Array”-type record from the Physical Topology Table having the “Element” variable matching the obtained value. The found Array record corresponds to the Array storage element, which includes the Logical Partition exclusively allocated to the specific User.

At step 1630, the system determines whether the value of the “Mode” variable of the Array-type record found at step 1620 is “Physical.” If so, the process proceeds to step 1640. Otherwise, if the corresponding variable value is “Virtual,” the process proceeds to step 1650.

At step 1640, the system inserts a new record representing the User into the Drawing Topology Table. The newly inserted record has the same values of “Element”, “Type” and “Target” variables as the record, which was obtained at step 1610. By default, the value of the “Icon” variable of the inserted record will be set to “null”.

At step 1650, the system selects a record from the Logical Partition Table shown in FIG. 4, which has the values of the “Storage Device” variable 610 and the “User” variable 630 equal to the values of the “Target” variable 530 and the “Element” variable 510, respectively, of the record which was obtained at the step 1610.

At step 1660, the inventive system inserts a new record into the Drawing Topology Table representing the User connected to a specific Logical Partition (Virtual Storage). The value of the “Element” variable of the inserted record is equal to the value of the “Element” variable of the record obtained at step 1610. The value of the “Type” variable is set to “User”, while the “Target” variable is set to have the value of the “Logical Partition” variable of the record obtained at step 1650. Finally, by default, the value of the “Icon” variable is set to “null”. Thus, the inserted record carries the information on the link between the User and the corresponding Logical Partition.

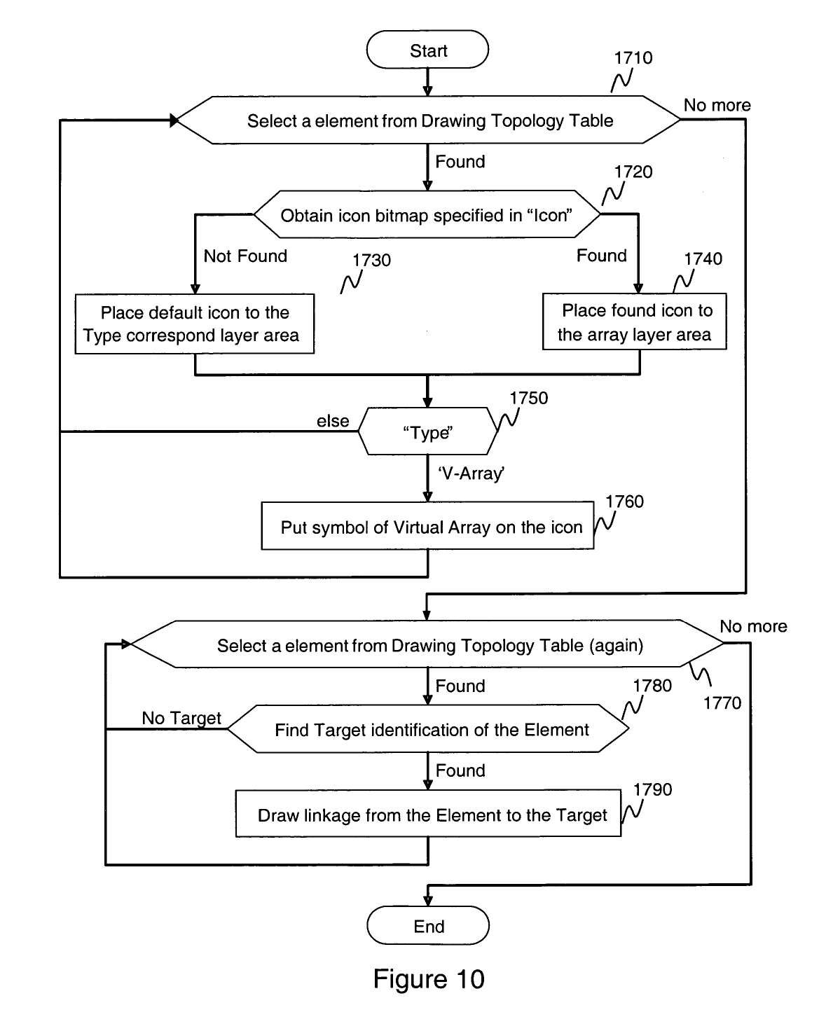

2) Drawing Topology (FIG. 10)

FIG. 10 shows an exemplary embodiment of a process flow for drawing the storage system topology view representing both the physical and virtual portions of the storage architecture. In the shown process flow, steps 1710 through 1760 draw icons for each storage element, while steps 1770 to 1790 draw graphical representations of relationships between the user and array elements of the storage system.

At step 1710, the system selects a record from the Drawing Topology Table. The selected record corresponds to a storage topology element. If icons corresponding to all storage topology elements have been already drawn, and no more unprocessed records remain in the Drawing Topology Table, the process proceeds to the step 1770.

At step 1720, the system obtains an icon bitmap of the element. If the specified icon bitmap is found, the process proceeds with step 1740. Otherwise, the process proceeds to step 1730. At step 1730, a default bitmap icon corresponding to the specific type of the Drawing Topology Table record is placed in a proper layer area of the system's user interface.

At step 1740, the found bitmap icon, which was specified in the Drawing Topology Table record, is likewise placed within the proper layer area the inventive system's user interface.

At step 1750, the system checks the value of the “Type” variable of the record. If the “Type” value is ‘V-Array’ (which corresponds Logical Partition), the process proceeds to step 1760. Otherwise, the operation flow goes back to step 1710.

At step 1760, the system draws a special symbol bitmap, which indicates the drawn topology element is a Virtual Storage element. At step 1770, the inventive system selects a new record of a topology element from the beginning of the Drawing Topology Table. If there are no more unprocessed record remain in the Drawing Topology Table, the process is terminated.

At step 1780, the system checks the value of the “Target” variable of the record. If its value is ‘null’, then the process proceeds back to the step 1770. At step 1790, the system draws a linkage line connecting the icon image of the “Element” with the “Target”. This line represents the correspondence between a User and the physical or virtual storage device.

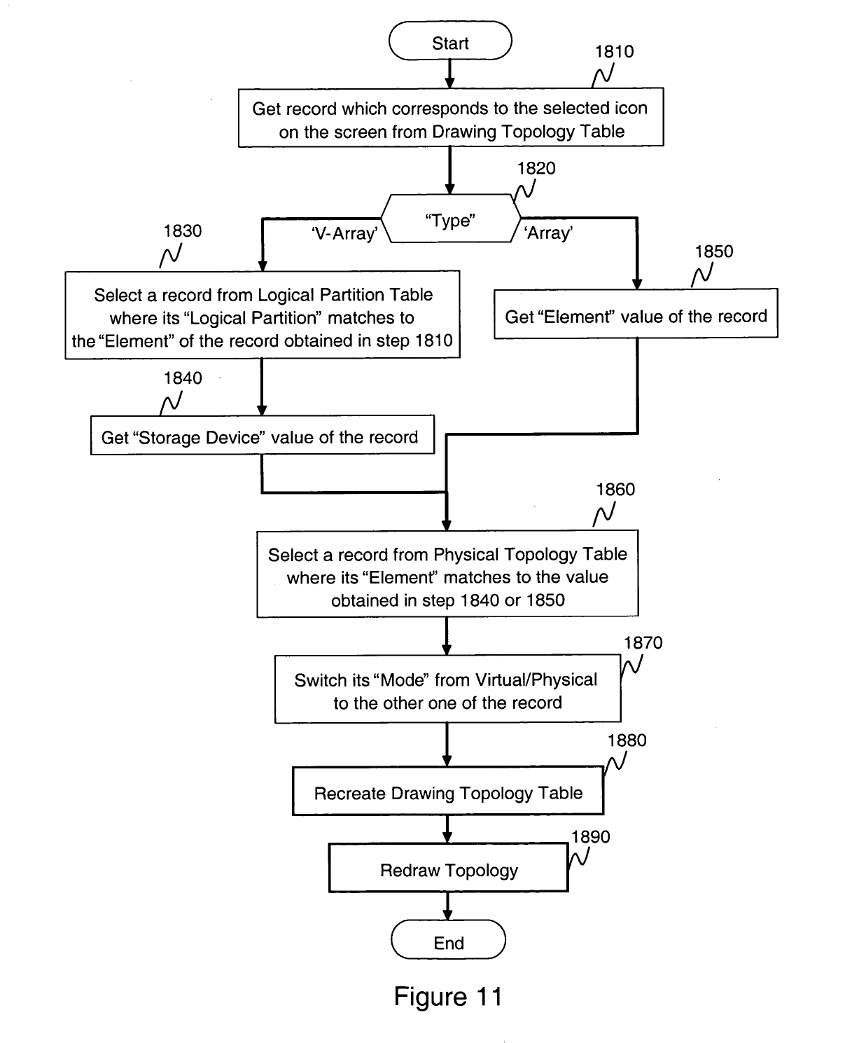

3) Switching Display of a Storage Device Portion within the Topology (FIG. 11)

FIG. 11 shows an exemplary embodiment of a process for switching the display of the storage device portion of the topology. This process starts when the user selects an appropriate menu item from the topology view, which was shown in FIG. 6 or 7.

It should be noted that the element identification information, which corresponds to the element selected on the screen is obtained when the process illustrated in FIG. 11 is started. At step 1810, the system obtains a record, which has a matching value of the variable “Element” from Drawing Topology Table.

At step 1820, the value of the “Type” variable of that record is checked and if it is ‘V-Array’ then the process proceeds to step 1830. If not, the process proceeds to step 1850. At step 1830, a record is selected from the Logical Partition Table, which has its “Logical Partition” value match the value of the “Element” variable of the record, which was obtained in step 1810.

At step 1840, the system obtains the value of the “Storage Device” variable (which corresponds to the identification of the physical device) of the record obtained in step 1830. At step 1850, the value of the “Element” variable is obtained (this is also identification of the physical device) of the record, which was obtained in step 1810. At step 1860, a record is selected from the Physical Topology Table, where the value of its “Element” variable matches the value obtained in step 1840 or 1850 (which is the identification of physical device).

At step 1870, the value of the “Mode” variable of the record is switched from ‘Virtual’ or ‘Physical’ or vice versa. This causes the change of the topology display mode when the topology is redrawn. At step 1880, the system recreates the Drawing Topology Table according with new status of Physical Topology Table. This process is already shown in FIGS. 8 and 9. Finally, at step 1890, the topology is redrawn with newly created Drawing Topology Table. This process has been illustrated in FIG. 10.

### Second Embodiment

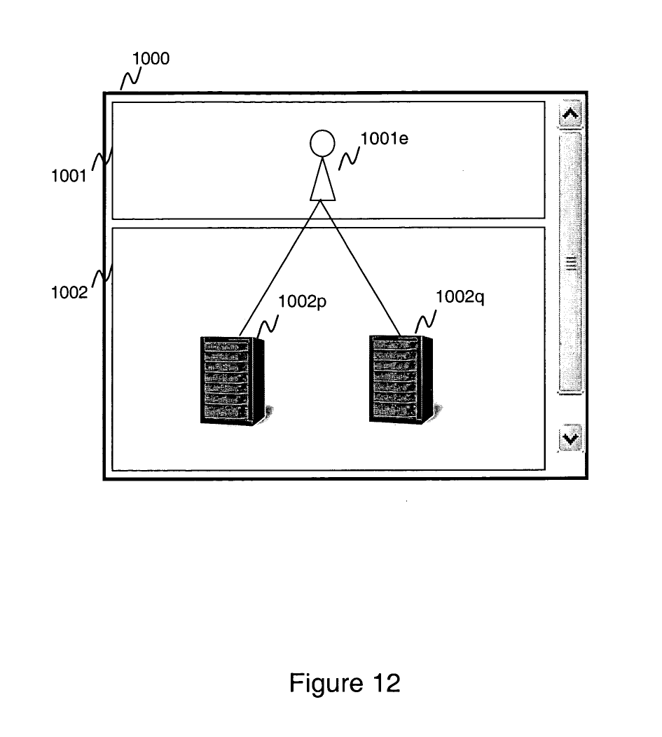

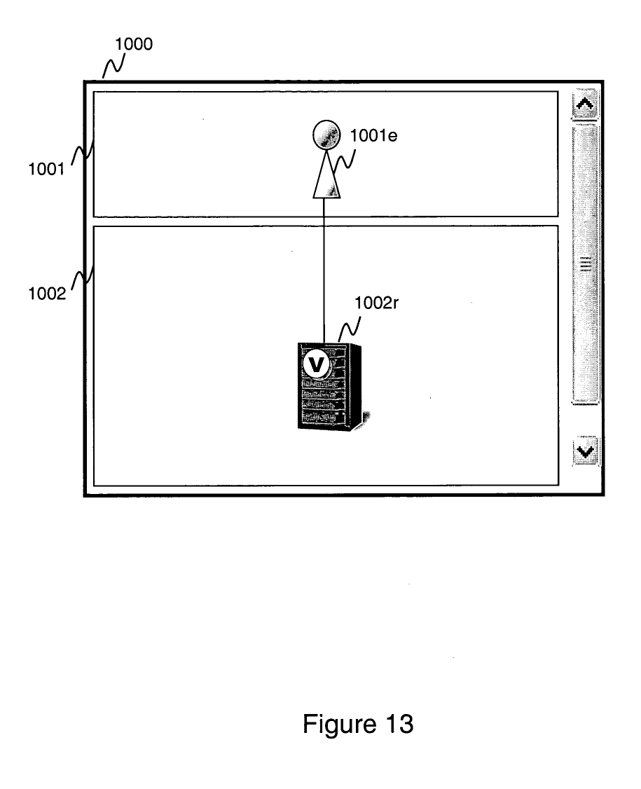

FIGS. 12 and 13 illustrate an exemplary embodiment of the user interface of the inventive Virtualized Storage Manager operating in connection with another implementation of the storage virtualization system. Specifically, in this implementation, a single virtual storage device may be composed of multiple physical storage units. FIG. 12 illustrates the Physical Storage View of the aforesaid storage system topology. In that view, user 1001e is shown to being linked to two physical data storage units 1002p and 1002q. The corresponding Virtual Storage View is shown in FIG. 13, which depicts the user 1001 being linked to the single virtual storage device 1002r, which is composed by the physical data storage units 1002p and 1002q.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data replication functionality. It is intended that the specification and examples be considered as exemplary only, with a true scope and spirit of the invention being indicated by the following claims.

What is claimed is:

1. A computerized data storage system comprising:
a. At least one physical storage device comprising a storage controller and least one storage disk, wherein the at least one physical storage device is apportioned into at least one logical partition;
b. A client host executing client software; and
c. A storage management server operable to execute a virtual storage manager and comprising a central processing unit, a memory and a network interface operable to connect the storage management server to the storage device and the client host via a network, wherein the virtual storage topology module is operable to:
i. Obtain information about the physical topology associated with the storage system, wherein the physical topology comprises information on the at least one physical storage device;
ii. Obtain information on the virtual topology associated with the storage system, wherein the virtual topology comprises information on the at least one logical partition within the storage system; and
iii. Cause at least a first portion of the physical topology information and at least a second portion of the virtual topology information top be displayed within the same topology view.

2. The computerized data storage system of claim 1, wherein the at least one logical partition comprises:
i. a port operable to enable communication with the at least one logical partition;
ii. a cache memory operable to cache data associated with the at least one logical partition; and
iii. a storage volume operable to store and retrieve data.

3. The computerized data storage system of claim 1, wherein the storage management server is further operable to receive a request from the user of the host and, responsive to the received request, to display properties of either a physical or a virtual topology element to the user.

4. The computerized data storage system of claim 1, wherein the virtual storage manager maintains a physical topology table comprising information on the at least one physical storage device.

5. The computerized data storage system of claim 4, wherein the physical topology table comprises:
a. An element record for storing information uniquely identifying the first topology element;
b. A type record for storing information on the type of the first topology element;
c. A target record for storing information identifying a fifth topology element linked to the first topology element; and
d. A mode record for storing information indicating a display mode of the first topology element.

6. The computerized data storage system of claim 1, wherein the virtual storage manager maintains a logical partition table comprising information on the at least one logical partition.

7. The computerized data storage system of claim 6, wherein the logical partition comprises:
a. A storage device record for storing information uniquely identifying the at least one physical storage device associated with the second topology element;
b. A logical partition record for storing information uniquely identifying the second topology element; and
c. A user record for storing information uniquely identifying a user associated with the second topology element.

8. The computerized data storage system of claim 7, wherein the logical partition table further comprises:
a. An icon record for storing information on a bitmap image used in displaying the second topology element;
b. A storage volume record for storing information identifying a storage volume associated with the second topology element;
c. A storage volume record for storing information identifying a cache memory associated with the second topology element; and
d. A port record for storing information identifying a port associated with the second topology element.

9. The computerized data storage system of claim 1, wherein the virtual storage manager maintains a drawing topology table comprising the first portion of the physical topology information and the second portion of the virtual topology information.

10. The computerized data storage system of claim 9, wherein the drawing topology table comprises at least one drawing topology element, and wherein the drawing topology element comprises:
a. An element record for storing information uniquely identifying the drawing topology element;
b. A type record for storing information on the type of the drawing topology element;
c. A target record for storing information identifying a target topology element linked to the drawing topology element; and
d. An icon record for storing information on a bitmap image used in displaying the drawing topology element.

11. A method for visualizing a topology associated with a computerized data storage system, the storage system comprising at least one physical storage device, the method comprising:
a. Obtaining information about the physical topology associated with the storage system, wherein the physical topology comprises information on the at least one physical storage device;
b. Obtaining information on the virtual topology associated with the storage system, wherein the virtual topology comprises information on logical partitions within the storage system; and
c. Displaying at least a first portion of the physical topology information and at least a second portion of the virtual topology information within the same topology view.

12. The method of claim 11, wherein the first portion of the physical topology information comprises a first topology element and wherein the method further comprises:
d. In response to a request from a user, displaying third portion of the virtual topology information corresponding to the first topology element.

13. The method of claim 11, wherein the second portion of the virtual topology information comprises a second topology element and wherein the method further comprises:
d. In response to a request from a user, displaying fourth portion of the physical topology information corresponding to the second topology element.

14. The method of claim 11, wherein the obtaining information about the physical topology comprises populating a physical topology table configured to store information on the at least one physical storage device.

15. The method of claim 14, wherein the physical topology table comprises:
a. Element record for storing information uniquely identifying the first topology element;
b. Type record for storing information on the type of the first topology element;
c. Target record for storing information identifying a fifth topology element linked to the first topology element; and
d. Mode record for storing information indicating a display mode of the first topology element.

16. The method of claim 11, wherein the obtaining information about the virtual topology comprises populating a logical partition table configured to store information on logical partitions within the storage system.

17. The method of claim 16, wherein the logical partition table comprises:
a. A storage device record for storing information uniquely identifying the at least one physical storage device associated with the second topology element;
b. A logical partition record for storing information uniquely identifying the second topology element; and
c. A user record for storing information uniquely identifying a user associated with the second topology element.

18. The method of claim 17, wherein the logical partition table further comprises:
a. An icon record for storing information on a bitmap image used in displaying the second topology element;
b. A storage volume record for storing information identifying a storage volume associated with the second topology element;
c. A storage volume record for storing information identifying a cache memory associated with the second topology element; and
d. A port record for storing information identifying a port associated with the second topology element.

19. The method of claim 11, wherein the displaying comprises populating a drawing topology table comprising the first portion of the physical topology information and the second portion of the virtual topology information.

20. The method of claim 19, wherein the drawing topology comprises at least one drawing topology element, and wherein the drawing topology record comprises:
a. An element record for storing information uniquely identifying the drawing topology element;
b. A type record for storing information on the type of the drawing topology element;
c. A target record for storing information identifying a target topology element linked to the drawing topology element; and
d. An icon record for storing information on a bitmap image used in displaying the drawing topology element.

21. The method of claim 20, wherein a value of the type record may be a virtual array, a physical array or a user.

22. The method of claim 21, further comprising sensing an activation of a displayed topology element by a user and, in response to the activation, displaying a menu bar to the user, the menu bar comprising an option for switching a display mode for the activated element.

23. A computer-readable medium, embodying computer-readable instructions, which, when executed by one or more processors, cause the one or more processors to:
a. Obtain information about the physical topology associated with a storage system comprising at least one physical storage device, wherein the physical topology comprises information on the at least one physical storage device;
b. Obtain information on the virtual topology associated with the storage system, wherein the virtual topology comprises information on logical partitions within the storage system; and
c. Display at least a first portion of the physical topology information and at least a second portion of the virtual topology information within the same topology view.
